(19) United States
(12) Patent Application Publication
(10) Pub. No.: US 2005/0122489 A1
(43) Pub. Date: Jun. 9, 2005

(54) Printing medium

(75) Inventor: Katsuhito Suzuki, Matsumoto-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/992,825

(22) Filed: Nov. 22, 2004

(30) Foreign Application Priority Data
Dec. 9, 2003 (JP) 2003-410121
Dec. 9, 2003 (JP) 2003-410122

(51) Int. Cl. G03B 27/32; G03B 35/14

(52) U.S. Cl. 355/22

(57) ABSTRACT

To provide a printing medium capable of improving an image quality and printing the image according to a precise position. A printing medium includes a print surface on which an image is printed, and a surface in which lenses are arranged, wherein, in the printing medium, the print image is viewed through the arranged lens, and at the time of printing, at least part of the arranged lens are located on the same side with the print surface.

### BACKGROUND

The present invention relates to a printing medium.

Conventionally, as a three-dimensional image, it has been widely known that a plurality of images shot from a plurality of directions are synthesized in a stripe, and parallax images recorded on a backside of a lenticular sheet (printing medium), where a plurality of cylindrical aspherical lenses is arranged on a surface, are transmitted from the surface side of the lenticular sheet through the cylindrical aspherical lens of the lenticular sheet and viewed with left and right eyes, so that the images are seen in three dimension.

In addition to the above-mentioned three-dimensional image, when the plurality of different images is converted into parallax images and recorded according to an observation direction, different images can be viewed according to a direction to be viewed.

Further, in addition to the above-mentioned lenticular sheet, the three-dimensional image can be obtained by using a so-called integral photography that uses a plurality of convex lenses (fly-eye lens) arranged in a planar shape.

Such three-dimensional images are obtained by arranging parallax images at positions corresponding to each of the plurality of lenses made of the cylindrical aspherical lens or fly-eye lens, so that it has a merit that special glasses such as glasses having different color for two eyes are not required.

However, in the case in which the position relationship of the parallax images to the plurality of lenses is not exact, left and right eyes observes different three-dimensional images of parallax images. As a result, the three-dimensional image or image may not be exactly viewed. For this reason, a technology for printing parallax images in the precise position relationship with the plurality of lenses has been suggested (for example, see Patent Documents 1 and 2).

[Patent Document 1] Japanese Unexamined Patent Application Publication No. 7-281327.

[Patent Document 2] Japanese Patent No. 3420394.

In the Patent Document 1, a backside of the lenticular lens is formed in a convex curve shape in the same pitch as that of the arrangement of the cylindrical aspherical lens (hereinafter, referred to as lenticular lens), and an ink absorption layer is formed at the backside thereof. Specifically, the parallax images are printed on the ink absorption layer of the lenticular lens and the position of the convex curve surface is detected by a sensor. As a result, a deviation factor of positions of the parallax images to the plurality of lenses is excluded so that the printing can be performed according to the precise position relationship.

In addition, in the Patent Document 2, a backside of the lenticular lens is provided with a rib in the same pitch as that of the arrangement of the lenticular lens and the inkjet recording layer for absorbing ink is formed in the backside thereof. Specifically, the parallax images are printed on the inkjet recording layer of the lenticular lens and position of the rib is detected by a sensor. As a result, a deviation factor of the parallax images to the plurality of lenses is excluded so that the printing can be performed in the precise position relationship.

However, for the direct printing of the lenticular sheet, there is a problem in that, even when the lenticular sheet made of a resin is coated with the ink absorption layer or the inkjet recording layer, the absorption of printed ink into the ink absorption layer etc. is not enough and the quality of parallax images is typically unsatisfactory.

Furthermore, when the print paper is used as a printed object to obtain the quality of the parallax images, the position of the parallax images with regard to the plurality of lenses becomes deviated. Therefore, the exact three-dimensional image or image may not be viewed.

In addition, the technology of adhering a protective sheet to the parallax images to protect the printed parallax image has been proposed. However, when the convex surface or the rib is formed as described in the above-mentioned Patent Document 1 and Patent Document 2, there are problems in that it is difficult to adhere the protective sheet to the print surface of the parallax image and the protective sheet is easily removed.

In addition, since the bask side of the lenticular lens is formed as the convex surface or the rib in both the above-mentioned Patent Document 1 and Patent Document 2, the its fabrication process is difficult due to its particular shape.

### SUMMARY

The present invention has been achieved in view of the drawbacks inherent in the prior arts, and it is an object of the present invention to provide a printing medium capable of printing parallax images in a precise positional relationship to the lens, as well as improving the quality of the parallax images.

In addition, it is another object of the present invention to provide a printing medium capable of printing parallax images in a precise positional relation to the lens, and being easily fabricated to adhere a sheet that protects the parallax images on a print surface.

In order to achieve the objects, according to an aspect of the present invention, there is provided a printing medium having a print surface on which an image is printed and a surface on which lenses are arranged, the print image being viewed through the arranged lenses, wherein, at the time of printing, at least some of the arranged lenses are located at the print surface side.

Specifically, the printing medium of the present invention can print images based on a shape and an arrangement interval of each of the lenses arranged on the same side with the print surface. Therefore, the images can be printed at a precise position with regard to the lens. Further, after printing, the images printed at the precise position can be viewed through lens. Moreover, when the lens is arranged on the printed images, the printed images can be protected with the lens, so that the image quality can be improved. In addition, when the lens is arranged at a surface other than the print surface, since there is no arranged on the printed surface, the printed images are easily protected using a protecting member such as a protective sheet. Thus, the image quality is easily improved.

In addition, in order to achieve the objects, according to another aspect of the present invention, there is provided a printing medium comprising: a print base material having a print surface on which an image is printed; and a lens sheet, wherein a lens is arranged on one side of the lens sheet, a surface on which the print surface of the print base material is provided and a surface of the other side of the lens sheet are fixed to each other at least at a partial area, and in the case of printing an image on the print surface, at least a part of the print base material and at least a part of the lens sheet are relatively moved to expose the print surface.

In other words, another printing medium of the present invention has a lens sheet and a print base material having a print surface, respectively, so that the print ink is easily absorbed into the print surface, and the quality of the printed images can be easily improved.

In addition, when the images are printed on the print base material, at least a part of the print base material is moved relative to at least part of the lens sheet to expose the print surface. Therefore, the images can be printed on the print surface without interfering with the lens sheet.

In addition, the print base material and the lens sheet are fixed to the part of the region, so that their positional relationship is not changed before and after printing. Moreover, even when the exposed printed surface is covered again with the lens sheet, the relative positional relationship between the print base material and the lens sheet is not changed. As a result, the images can be printed with a precise positional relationship to the lens.

To achieve the above configuration, more specifically, a turning unit that moves the print base material relative to the lens sheet to expose the print surface may be provided, at least at one side of the print base material or the lens sheet.

According to this configuration, since the turning unit is provided on at least one of the print base material and the lens sheet, the print base material and the lens sheet can be relatively moved from the turning unit. Therefore, it is ensured that the print surface is exposed.

To achieve the above configuration, more specifically, the turning unit may be formed at the remaining area of the lens sheet, and may be a folding unit folded to one side of the lens sheet.

According to this configuration, the lens sheet can be folded from the folding unit provided in the remaining region of the lens sheet. As a result, when the images are printed on the print base material, the lens sheet is folded to expose the print surface, thereby printing the images. In addition, the print base material and the lens sheet are combined at the port of region, so that their positional relationship is not changed before and after printing. Moreover, the lens sheet, which was folded, is not changed in the positional relationship even when it is combined into the print base material. As a result, the images can be printed with the exact relationship to the image lens.

To achieve the above configuration, more specifically, the remaining area of the lens sheet may be divided by at least one cut, and the divided part of the lens sheet is fixed to the print base material.

According to this configuration, since the part of lens sheet is fixed to the print base material in advance, the print position of the images can be determined based on the arrangement of the lens of the portion of lens sheet when the images are printed on the print surface. As a result, the print position of the images and the position of the lens can be more exactly determined.

To achieve the above configuration, more specifically, the fixing of the lens sheet to the print base material at the partial area may be performed using a fixing unit.

According to this configuration, the fixing of the lens sheet to the print base material at the part of the area is performed using a fixing unit, so that the lens sheet can be easily fixed to the print base material.

To achieve the above configuration, more specifically, the fixing of the print base material to the portion of the lens sheet may be performed using a fixing member.

According to this configuration, the fixing of the print base material to the part of the lens sheet is performed using a fixing member, so that the portion of the lens sheet can be easily fixed to the print base material.

To achieve the above configuration, more specifically, one side of the lens sheet may comprise a fixing member.

According to this configuration, since the other surface of the lens sheet comprises a fixing member, the fixing of the lens sheet to the print base material can be easily performed.

In addition, since the print surface of the print base material does not comprise the fixing member, degradation in the quality of image printed on the print surface can be prevented.

To achieve the above configuration, more specifically, the print base material may comprise a fixing member at the edge of the print surface.

According to this configuration, since the print base material comprises the fixing member at the edge of the print surface, the fixing of the lens sheet to the print base material can be easily performed.

In addition, since the fixing member is arranged only at the edge of the print surface, the center portion of the print surface where most images are printed is not affected. Therefore, degradation in the quality of image printed on the print surface can be prevented.

To achieve the above configuration, more specifically, the fixing member may be made of a paste or double-sided tape.

According to this configuration, since the fixing member is made of the paste or double-sided tape, the fixing of the lens sheet to the print base material can be easily performed.

To achieve the above configuration, more specifically, the fixing of the lens sheet to the print base material at the partial area may be performed using a pin.

According to this configuration, since the fixing of the lens sheet to the print base material at the partial area is performed using a pin, the lens sheet can be tightly adhered to the print base material.

To achieve the above objects, there is provided a printing medium having one surface on which lenses are arranged and the other surface on which a planar-shaped print surface on which an image is printed is formed, wherein at least one folding unit is provided substantially perpendicular to the lenses and is thinner than other regions.

In other words, in the printing medium of the present invention, the side other than that where the print face is formed has a planar shape. Therefore, for example, a sheet protecting images printed on the print surface can be easily adhered. In addition, since the other side has the planar shape, it can be easily fabricated without a specific process. As a result, the printing medium having the other surface can also be easily fabricated.

By forming the folding unit substantially perpendicular to the lenses, the printing medium can be folded from the folding unit so that the lens of the folded printing medium becomes suitable to the print surface. As a result, the position of the images printed on the print surface can be determined based on the arrangement position and arrangement pitch of the lens, so that the images can be printed in a precise positional relation to the lens.

Here, a substantial perpendicular to the lenses refers to a substantial perpendicular to the longitudinal rectangular axis direction of the lenticular lens in the case of the lenticular lens, which is a cylindrical aspherical lens, and a substantial perpendicular to the straight line binding the center of each fly-eye lens in the case of the integral sheet on which the fly-eye lens is arranged.

To achieve the above configuration, more specifically, the folding unit may a cut opening toward the one side.

According to this configuration, the printing medium can be easily folded from the folding unit to the other side of the print surface, so that the lens of the folded printing medium is easily turned.

To achieve the above configuration, more specifically, a fixing member may be arranged to fix the other surface in at least a part of a region in which folded faces of the other surface oppose to each other when folded by the folding unit.

According to this configuration, since the fixing member is arranged at least at a part of the region, the printing medium folded from the folded back portion can be easily fixed. As a result, when the parallax images are printed on the print surface, the arrangement position and the arrangement pitch of the folded lens are easily measured so that the parallax images can be easily printed with a precise positional relationship to the lens.

To achieve the above configuration, more specifically, the fixing member may be a paste or double-sided tape.

According to this configuration, the paste or double-sided tape is used for the fixing member. At this time, since the particular process and method is not required in preparing the paste or double-sided tape on the one side, the printing medium can be easily fabricated.

### BRIEF DESCRIPTION OF THE DRAWINGS

FIG. 1 is an exploded perspective view showing an example of a lenticular sheet according to a first embodiment of the present invention;

FIG. 2 is a plan view showing a lens sheet of the lenticular sheet shown in FIG. 1;

FIG. 3 is a perspective view showing an example of the lenticular sheet shown in FIG. 1;

FIG. 4 is an exploded perspective view showing a modified example of the lenticular sheet shown in FIG. 1;

FIG. 5 is a cross sectional view showing a behavior of the lenticular sheet shown in FIG. 1;

FIG. 6 is an exploded perspective view showing a modified example of the lenticular sheet shown in FIG. 1;

FIG. 7 is a perspective view showing an example of a lenticular sheet according to a second embodiment of the present invention;

FIG. 8 is a perspective view of an example of the lenticular sheet shown in FIG. 7; and

FIG. 9 is a cross sectional view for explaining a behavior of the lenticular sheet shown in FIG. 9.

### DETAILED DESCRIPTION OF EMBODIMENTS

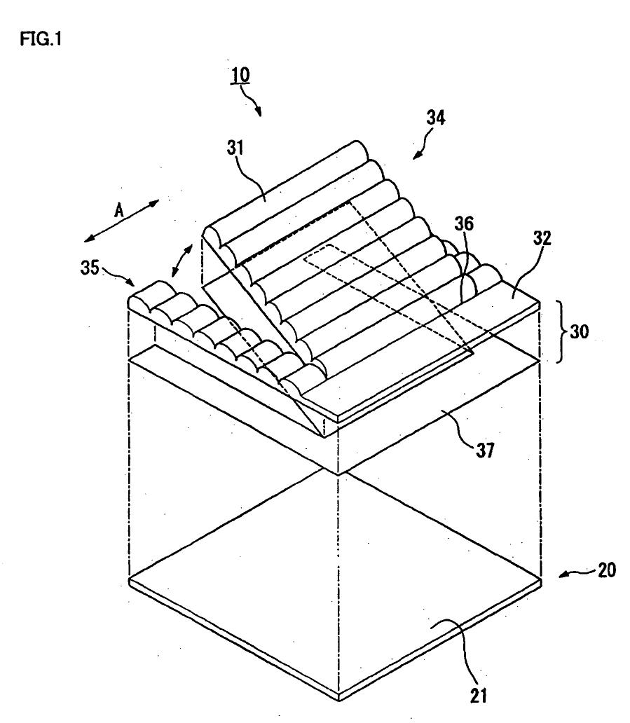

A lenticular sheet according to a first embodiment of the present invention will now be described with reference to FIGS. 1 to 5.

FIG. 1 is an exploded perspective view showing an example of a lenticular sheet according to a first embodiment of the present invention.

As shown in FIG. 1, a lenticular sheet (printing medium) 10 schematically comprises a print paper (print base material) 20 on which parallax images are printed, and a lens sheet 30 on which a plurality of lenticular lenses (lenses) 31, i.e., a cylindrical aspherical lens (cylindrical lens), is formed.

The print paper 20 has a print surface 21 on which parallax images are printed using ink. As the print paper 20, the well-known sheet used for printing, such as a photo paper and an OHP film, can be used.

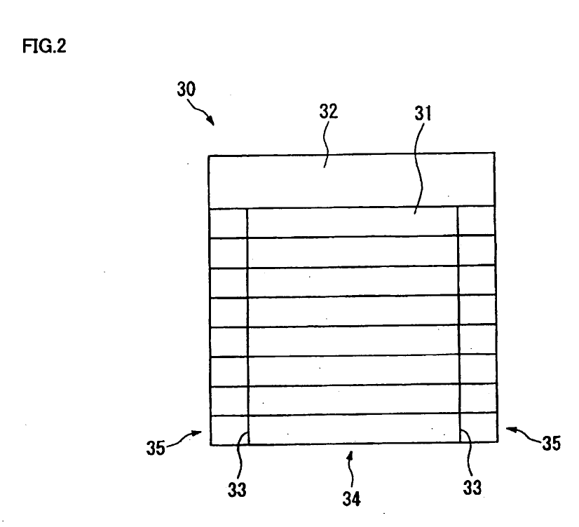

FIG. 2 is a plan view of a lens sheet according to the present invention.

As shown in FIGS. 1 and 2, the lens sheet 30 has the plurality of lenticular lenses 31 provided almost over one side of the lens sheet in parallel or at the same interval in a longitudinal axis direction (in a direction of arrow A in FIG. 1), and an attaching unit (a part of region) 32 arranged in a portion adjacent to the one side on which the lenticular lens 31 is not formed. The region where the lenticular lens 31 is formed can be divided into an observation lens sheet 34 at the center and detection lens sheets (a part of lens sheet) 35 at both sides of the observation lens sheet 34, by two cuts 33 formed in a direction substantially perpendicular to the lenticular lens 31. As a result, shapes, arrangement positions and arrangement pitches of the lenticular lenses 31 are equal to each other for the observation lens sheet 34 and the detection lens sheets 35.

In addition, two cuts 33 may be provided as described above, or one cut 33 may be provided. In the latter case, the observation lens sheet 34 can be fabricated to have a large area so that the printable area of the parallax images for the lenticular sheet 10 can be made large.

A folding unit (turning unit) 36 is provided between the attaching unit 32 and the observation lens sheet 34 in substantially parallel to the lenticular lens 31 to fold back the observation lens sheet 34 into the side of the lenticular lens 31.

Moreover, the surface of the one side of the attaching unit 32 may be formed with the lenticular lens 31 as described above, and may not be formed with the lenticular lens 31. In this case, the lenticular lens 31 is easily fabricated so that the lenticular sheet 10 is also easily fabricated.

The surface of the other side of the lens sheet 30 where the lenticular lens 31 is not formed is formed in a planar shape so as to facilitate the close adherence to the print paper 20 and is provided with a double-sided tape (fixing member) 37 for attaching to the print paper 20.

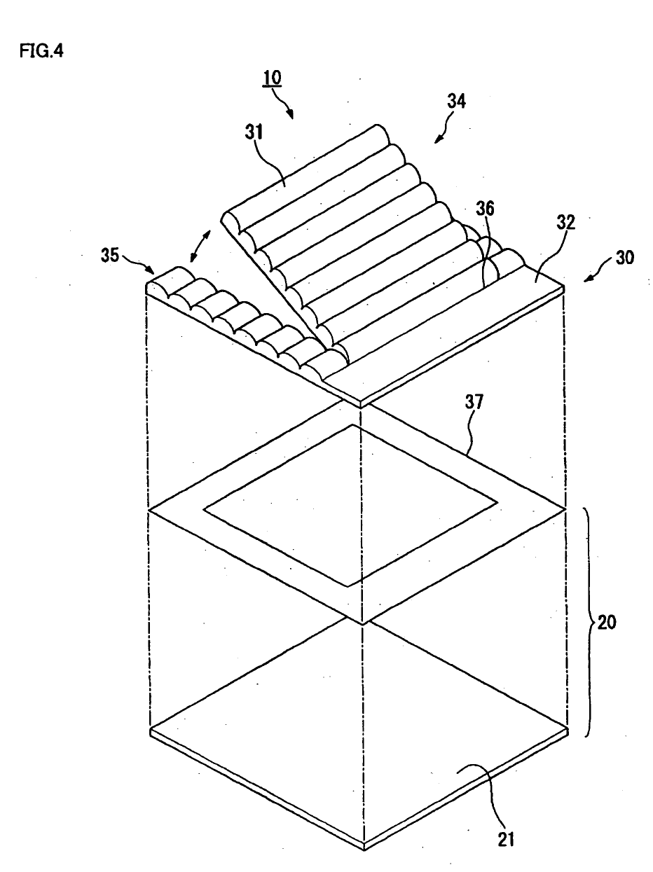

Further, as described above, the double-sided tape 37 may be prepared on the lens sheet 30 to adhere to the print paper 20, and a paste instead of the double-sided tape 37 may be prepared on the lens sheet 30 to adhere to the print paper 20. In addition, instead of arranging the double-sided tape 37 on the lens sheet 30, the double-sided tape 37 may be provided around the edge of the print paper 20 as shown in FIG. 4, or alternatively, the paste may be provided around the edge of the print paper 20. Since the paste or double-sided tape is provided only around the edge of the printing side, there is little influence on the center of the print surface where most images are printed. Therefore, degradation of the image quality can be prevented.

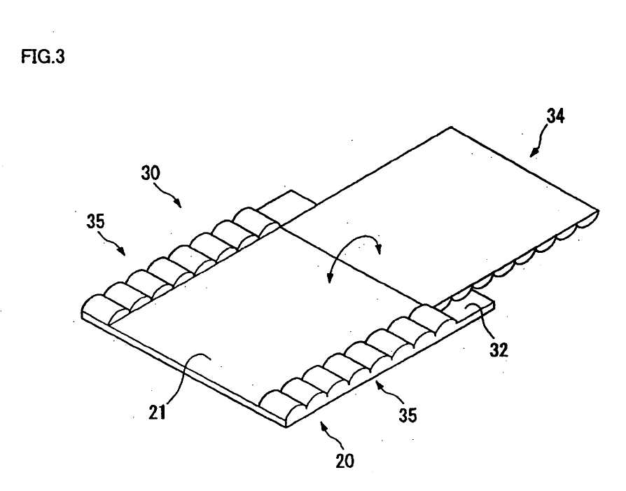

FIG. 3 is a perspective view of the lenticular sheet according to the present invention.

The print paper 20 is arranged such that the print surface 21 faces the lens sheet 30, and the lens sheet 30 is arranged such that the surface of the other side where the lenticular lens 31 is not formed faces the print paper 20.

As shown in FIG. 1, the print paper 20 and the lens sheet 30 are attached to the attaching unit 32 and the detection lens sheet 35. The observation lens sheet 34 is folded from the folding unit 36 into the side of the lenticular lens 31, as shown in FIG. 3, so that the central portion of the print surface 21 of the print paper 20 is exposed.

Next, a function of the lenticular sheet 10 having the above structure will be described.

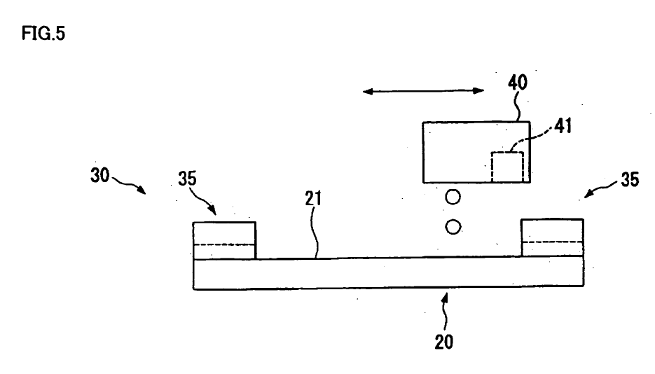

FIG. 5 is a sectional view for explaining a method of printing the lenticular sheet according to the present invention.

The printing of the above-mentioned lenticular sheet 10 is performed as follows. First, in a state in which the print surface 21 is exposed by folding the observation lens sheet 34 of the lens sheet 30 toward the side of the lenticular lens 31 as shown in FIG. 1, the lenticular sheet 10 is set to a printing device 40 using an inkjet method as shown in FIG. 5.

Next, the printing device 40 detects an arranged position of the lenticular lens 31 of the detection lens sheet 35 at least at one side of the detection lens sheets 35 arranged at both sides of the print surface 21, using a sensor 41 provided in the printing device 40.

The printing device 40 prints parallax images on the print surface 21 with print ink, based on arrangement position information of the lenticular lens 31 detected by the sensor 41.

When the parallax images are printed on the print surface 21, the lenticular sheet 10 is removed from the printing device 40. In addition, the observation lens sheet 34 of the lens sheet 30 folded toward the side of the lenticular lens 31 is unfolded to attach the printing side 21 to the observation lens sheet 34 of the lens sheet 30 using the double-sided tape 37 arranged at the lens sheet 30. Therefore, the printing of the lenticular sheet 10 is ended.

According to the above-mentioned configuration, since the print paper 20 and the lens sheet 30 are respectively provided so as to print images, the printing ink is easily absorbed into the print surface 21 of the print paper 20, and the image quality printed on the lenticular sheet 10 can be easily improved.

In addition, the print paper 20 and the lens sheet 30 are adhered to the attaching unit 32 so that the observation lens sheet 34 is folded toward the lenticular lens 31 from the folding unit 36. As a result, when the parallax images are printed on the print paper 20, the observation lens sheet 34 is folded to expose the print surface 21 as shown in FIG. 3, so that the parallax images can be printed on the print surface 21.

In addition, since the print paper 20 and the lens sheet 30 are adhered to the attaching unit 32, the positional relationship is not changed before and after printing the parallax images. Moreover, even when the observation lens sheet 34 is adhered to the print paper 20, the positional relationship is not changed. As a result, the parallax images can be printed in a precise positional relationship to the lens sheet 30.

Since the detection lens sheet 35 is previously adhered to the print paper 20, the print position of the parallax images can be determined based on the lens arrangement of the detection lens sheet 35 when the parallax images are printed on the print surface 21. As a result, the print position of the parallax image and the position of the lenticular lens 31 can be more accurately determined.

In the attaching unit 32, the adhering of the print paper 20 to the lens sheet 30 is performed using the paste or double-sided tape 37, so that the lens sheet 30 can be easily adhered to the print paper 20. In addition, the adhering of the print paper 20 to the detection lens sheet 35 is performed using the paste or double-sided tape 37, so that the print paper 20 can be easily adhered to the detection lens sheet 35.

The surface where the lenticular lens 31 of the lens sheet 30 is not formed is provided with the paste or double-sided tape 37, so that the adhering of the print paper 20 to the lens sheet 30 can be easily performed. In addition, since the print surface 21 of the print paper 20 is not provided with the paste or double-sided tape 37, degradation in the quality of image printed on the print surface 21 can be prevented.

The detection lens sheets 35 are arranged at both sides of the print surface 21, so that when the parallax images are printed on the print surface 21, the arrangement position and the arrangement pitch of the lenticular lens 31 can be detected from both sides of the detection lens sheets 35. As a result, the print can be started from both sides of the detection lens sheets 35, thereby improving the print speed.

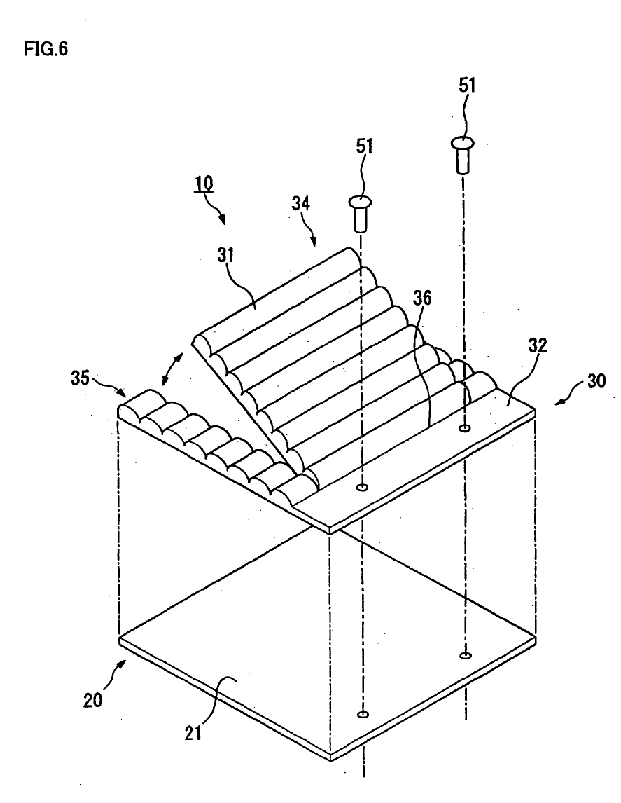

Moreover, in the attaching unit 32, the adhering of the print paper 20 to the lens sheet 30 may be performed using the paste or double-sided tape as described above. In addition, in the attaching unit 32, the adhering of the print paper 20 to the lens sheet 30 may be performed using pins 51 as shown in FIG. 6. In this case, the adhesive strength of the print paper 20 to the lens sheet 30 is improved, so that until the parallax images are completely printed on the print paper 20, the removing of the lens sheet 30 from the print paper 20 can be effectively prevented.

Moreover, the present invention is not limited to the above-mentioned embodiment, and a variety of modification can be made without departing from the spirit of the present invention.

For example, while, in the above-mentioned embodiment, the lenticular lens 31 is arranged as the lens sheet 30, the present invention is not limited to the above-mentioned embodiment in which the lenticular lens 31 is arranged as the lens sheet 30. A fly-eye lens and other various lenses may be used as the lens sheet.

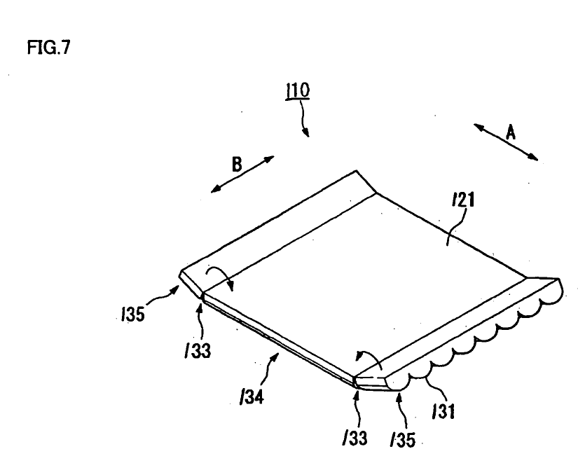

Next, a lenticular sheet according to a second embodiment of the present invention will now be described with reference to FIGS. 7 to 9.

FIG. 7 is a perspective view of a lenticular sheet according to a second embodiment of the present invention as viewed from a backside.

As shown in FIG. 7, a lenticular sheet (printing medium) 110 comprises a plurality of lenticular lenses (lenses) 131 which are cylindrical aspherical lenses (cylindrical lens) on a surface of one side, and a print surface 121 made of an ink absorption layer on a surface of the other side. The lenticular lenses 131 are arranged parallel or at the same interval in a longitudinal axis direction (in a direction of arrow A in FIG. 7).

The lenticular sheet 110 is provided with folding units 133 formed in substantially parallel to each other, as two cuts opening toward the side of the lenticular lens 131, and the folding units 133 are formed so as to extend in a direction (in a direction of arrow B in FIG. 7) substantially perpendicular to the longitudinal axis direction of the lenticular lenses 131. By using two folding units 133, the lenticular sheet 110 can be divided into an observation lenticular sheet 134 at the center and detection lenticular sheets 134 at both sides. As a result, for the observation lenticular sheet 134 and the detection lenticular sheets 135, a shape, an arrangement position and an arrangement pitch of the lenticular lens 131 are equal to each other.

Moreover, the two folding units 133 may be provided as described above, or alternatively, only one folding unit 133 may be provided. In the latter case, the observation lenticular sheet 134 can be fabricated with a large area so that the printable area of the parallax images for the lenticular sheet 110 can be made large.

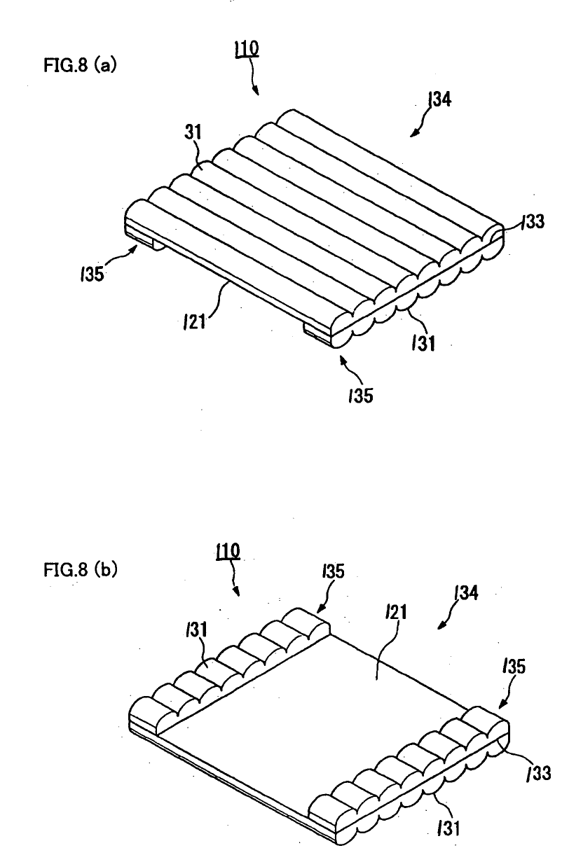

FIG. 8(a) is a perspective view of the lenticular sheet folded from the folding units, and FIG. 8(b) is a perspective view of the lenticular sheet folded from the folding unit as viewed from a backside.

Since the folding unit 133 opens toward the side of the lenticular lens 131, the detection lenticular sheet 135 can be folded back around the print surface 121 of the observation lenticular sheet 134 in reference to the folding unit 133, as shown in FIGS. 8(a) and 8(b).

Moreover, as described above, the detection lenticular sheet 135 may be folded around the print surface 121 of the observation lenticular sheet 134, or alternatively, by arranging adhesion such as a paste or double-sided tape (fixing member) on at least at the portion of the area where the detection lenticular sheet 135 and the print surface 121 of the observation lenticular sheet 134 overlap, the folded detection lenticular sheet 135 may be adhered to the print surface 121 of the observation lenticular sheet 134.

Next, a function of the lenticular sheet 110 having the above-mentioned configuration will be described.

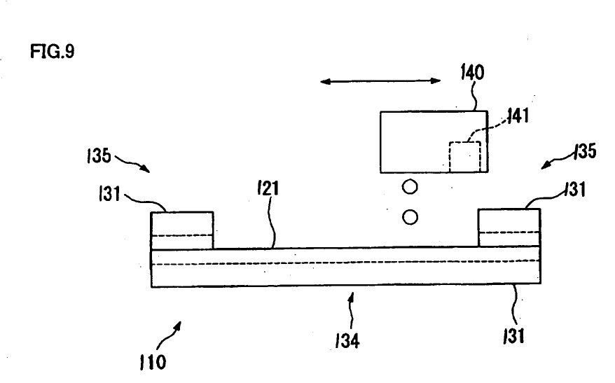

FIG. 9 is a sectional view for explaining a method of printing the lenticular sheet according to the present invention. The printing of the above-mentioned lenticular sheet 110 is performed as follows. First, in a state in which the print surface 121 of the observation lenticular sheet 134 faces upward by folding the detection lenticular sheet 135 toward the print surface 121 of the observation lenticular sheet 134 as shown in FIGS. 8(a) and 8(b), the lenticular sheet 110 is set to a printing device 140 using an inkjet method, as shown in FIG. 9.

Next, the printing device 140 detects an arranged position of the lenticular lens 131 of the detection lenticular sheet 135 at least at one side of the detection lenticular sheets 135 arranged at both sides of the print surface 121, using a sensor 141 provided in the printing device 140.

The printing device 140 prints parallax images on the print surface 121 with printing ink, based on arrangement position information of the lenticular lens 131 detected by the sensor 141.

When the parallax images are printed on the print surface 121, the lenticular sheet 110 is removed from the printing device 140. Therefore, the printing of the lenticular sheet 110 is ended.

Next, the detection lenticular sheet 135 folded along the print surface 121 of the observation lenticular sheet 134 extends again or is cut, and the print surface 121 is provided in a planar shape, and then, a protective sheet for protecting the parallax images may be adhered to the print surface 121, and a protective layer can be formed through a process of depositing and drying a liquid protective material. In addition, when the detection lenticular sheet 135 is adhered using the paste or double-sided tape, the protective sheet may be adhered only to the exposed print surface 121, or alternatively, the protective sheet may be adhered after removing the area where the paste or double-sided tape is attached.

According to the above-mentioned configuration, since the surface where the print surface 121 is formed has a planar shape, the protective layer (protective sheet), for example, can be easily adhered to the print surface 121 to protect the printed parallax images. In addition, since the print surface 121 has a planar shape, it can be easily fabricated without necessitating a particular process or method of forming the print surface 121. As a result, the lenticular sheet 110 having the print surface 121 can be easily fabricated.

The folding unit 133 that is substantially perpendicular to the lenticular lens 131 is provided. As a result, the detection lenticular sheet 135 can be folded from the folding unit 133 and the lenticular lens 131 of the folded detection lenticular sheet 135 faces to the print surface 121 of the observation lenticular sheet 134. As a result, the position of the parallax images printed on the print surface 121 can be determined based on the arrangement position and arrangement pitch of the lenticular lens 131 in the detection lenticular sheet 135, so that the parallax images can be printed with a precise position relationship to the lenticular lens 131.

Since the detection lenticular sheets 135 are arranged at both side of the print surface 121, the arrangement position and the arrangement pitch of the lenticular lens 131 can be detected from both detection lenticular sheets 135 when the parallax images are printed on the print surface 121. For this reason, the printing can be started from both detection lenticular sheets 135, so that the print speed can be improved.

Moreover, the scope of the present invention is not limited to the above-mentioned embodiments, and a variety of modifications can be made without departing from the spirit of the present invention.

For example, while the above-mentioned embodiments has been described with reference to the lenticular sheet 110 on which the lenticular lens 131 are arranged, the present invention is not limited to the above-mentioned embodiments that the lenticular sheet 110 is used. Therefore, an integral sheet having a fly-eye lens and other lens sheets using various lenses can be also applied.

1. A printing medium comprising:
a print surface on which an image is printed; and
a surface on which lenses are arranged,
the print image being viewed through the arranged lenses,
wherein, at the time of printing, at least some of the lenses are arranged at the print surface side.

2. A printing medium comprising:
a print base material having a print surface on which an image is printed; and
a lens sheet
wherein lenses are arranged on one surface of the lens sheet,
a surface on which the print surface of the print base material is provided and a surface of the other side of the lens sheet are fixed to each other at least at a partial area, and
in the case of printing an image on the print surface, at least a part of the print base material and at least a part of the lens sheet are relatively moved to expose the print surface.

3. The printing medium according to claim 2, wherein a turning unit that the print base material and the lens sheet are relatively moved to expose the print surface is provided on at least one of the print base material and the lens sheet.

4. The printing medium according to claim 3, wherein the turning unit is formed at the remaining area of the lens sheet, and is a folding unit folded to one side of the lens sheet.

5. The printing medium according to claim 2, wherein the remaining area of the lens sheet is divided with at least one cut, and the divided part of the lens sheet is fixed to the print base material.

6. The printing medium according to claim 2, wherein the fixing of the lens sheet to the print base material at the partial area is performed using a fixing member.

7. The printing medium according to claim 2, wherein the fixing of the part of the lens sheet to the print base material is performed using a fixing member.

8. The printing medium according to claim 2, wherein a fixing unit is provided at the surface of the other side of the lens sheet.

9. The printing medium according to claim 2, wherein a fixing unit is provided at an edge of the print surface of the print base material.

10. The printing medium according to claim 6, wherein the fixing unit is a paste or double-sided tape.

11. The printing medium according to claim 2, wherein the fixing of the lens sheet to the print base material at the partial area is performed using a pin.

12. A printing medium comprising:
one surface on which lenses are arranged; and
the other surface on which a planar shaped print surface on which an image is printed is formed,
wherein at least one folding unit is provided substantially perpendicular to the lenses and is thinner than other regions.

13. The printing medium according to claim 12, wherein the folding unit is a cut opening toward the one surface.

14. The printing medium according to claim 12, wherein a fixing member is arranged so as to fix the other surface in at least a part of a region in which folded faces of the other surface oppose to each other when folded by the folding unit.

15. The printing medium according to claim 14, wherein the fixing unit is a paste or double-sided tape.
